(19) United States
(12) Patent Application Publication
(10) Pub. No.: US 2002/0026307 A1
(43) Pub. Date: Feb. 28, 2002

(54) Speech analysis method

(76) Inventor: Tobias Ruland, Munchen, DE (US)

Correspondence Address: STAAS & HALSEY LLP, 700 11TH STREET, NW, SUITE 500, WASHINGTON, DC, 20001, US

(21) Appl. No.: 09/897,421

(22) Filed: Jul. 3, 2001

(30) Foreign Application Priority Data
Jul. 3, 2000 (DE) 10032255.7

(51) Int. Cl. G06F 17/27

(52) U.S. Cl. 704/9

(57) ABSTRACT

A method for computer-supported speech analysis, in which a syntactic structure is assigned to an utterance. In this process, assignments are made with probabilities which depend on an expanded context.

### CROSS-REFERENCE TO RELATED APPLICATIONS

This application is based upon and claims priority to German Application No. 100 32 255.7, filed Jul. 3, 2000, the contents of which are incorporated herein by reference.

### BACKGROUND OF THE INVENTION

The invention relates to a method, an arrangement and a program product for speech analysis.

In this process, a syntactic structure is assigned to an utterance. For this purpose, the utterance is divided into speech units. In the most frequent cases, the division is performed in such a way that a word forms a speech unit. A speech category is then assigned to each of these speech units. The speech categories of the speech units in a syntactic structure represent its grammatical function.

The syntactic structure of an utterance is obtained by successively applying speech structure rules which form the grammar. The application of a speech structure rule is referred to as an action. In the speech analysis, the speech category of the first speech unit is used starting from an initial state. A specific action is assigned to the combination of speech category and speech unit in a deterministic language, for example a computer language. This procedure is known, for example from compilers, the assignment being made in a parsing method by a parsing table.

In a natural language which has ambiguities, it is in many cases no longer possible to assign a specific action but instead a plurality of actions can be assigned depending on the ambiguities of the language. In order to find a preferred syntactic structure such as is generally required in speech analysis, different probabilities are assigned to the actions. By carrying out the actions, a number of resultant states is determined on the basis of the given state. When there are alternative actions, all possible resultant states compete with one another, which can be used to exclude from further consideration those resultant states with lower probabilistic evaluations. J. H. Wright and E. N. Wrigley “GLR-Parsing with Probability” in M. Tomita “Generalized LR-Parsing”, Kluwer Academic Publishers, Boston, 1991, use this method to carry out a type of search in which only the best competing sequences of actions and resultant states are used for the further analysis.

The problem is then in determining the probabilities for the different actions. T. Briscoe and J. Carroll “Generalized Probabilistic LR-Parsing of Natural Language (Corpora) with Unification-Based Grammars” in “Computational Linguistics”, Vol. 19, No. 1, 1993 determine these probabilities as a function of context by making them dependent on the resultant states and the speech categories.

### SUMMARY OF THE INVENTION

Taking this as the basis, one aspect of the invention is based on the object of making available a method, an arrangement and a computer program product for computer-supported speech analysis, in particular for parsing, with which more precise and more informative probabilities can be determined for the individual actions.

In the method according to the prior art, the probabilities for the actions are always determined only as a function of the syntactic variables in a parsing method in the parsing table. These variables are referred to as context in the narrower sense and comprise speech category, states, including resultant states, and actions. The method according to one aspect of the invention goes beyond this in that it also takes into account syntactic variables for calculating the probabilities, which syntactic variables are not used in the calculation of the probabilities nor in the assignment of an action to the combination of state and speech category in the methods according to the prior art. These syntactic variables form the expanded context.

A syntactic variable which is preferred in the expanded context is the dialogue act of the utterance. If the utterance has, for example, the “greeting” dialogue act, and the utterance is then a greeting formula values for the probabilities for a combination of state and speech category will be obtained which are different from those for the same combination of state and speech category in the case of an utterance with the “description” dialogue act.

In contrast to the context in the narrower sense, which contains only the speech category of one speech unit, the expanded context can also contain the speech unit itself. Further information, which is taken into account in the determination of the probabilities and thus ultimately in the evaluation of the actions, can also be associated with this speech unit itself. Furthermore, the probabilities can also depend on further speech units of the utterance.

A further syntactic variable which is preferred in the expanded context is the speech style with which the speech unit and/or the utterance have been reproduced. This variable occurs, of course, only if the utterance which is to be analyzed is actually spoken language or if a speech style is assigned to it in some other way.

For a simpler analysis it is recommended to allocate an order to the speech units and to process them in this order. The simplest, and as a rule most appropriate order results from the order of the speech units in the utterance. However, for example the inverted order of the speech units in the utterance is also possible.

As a rule, the data material available will not be sufficient to determine the dependence of the probabilities on all the syntactic variables in the expanded context. It is therefore advantageous to combine a plurality of syntactic variables of the context to form a subcontext and to approximate the probability of an action in a context by calculating the probabilities of the action in the subcontexts.

It is recommended to resort to a stochastic parsing, in particular a stochastic LR-parsing for the computer-supported speech analysis because these methods have become sufficiently known and have been sufficiently implemented. The stochastic LR-parsing has here also the advantage of a very high processing speed. This applies in particular if a parsing table is used for the assignment of one or more actions to a combination of state and speech category.

If a stack is used in such parsing, it has proven advantageous in connection with one aspect of the invention if the expanded context contains the non-terminal grammatical symbol of the uppermost stack element or the phrase head of the uppermost stack element.

The speech analysis method can be used in speech processing both for speech recognition and speech synthesis.

An arrangement which is configured to carry out one of the methods described can be implemented, for example, by appropriately programming and configuring a computer or a computing system.

A data processing system program product which contains software code sections with which one of the described methods can be carried out on the data processing system can be carried out by suitably implementing the method in a programming language and converting it into code which can be executed by the data processing system. To do this, the software code sections are stored. Here, when the term program product is used, program is understood to be a tradeable product. It may take any desired form, for example paper, a computer readable data carrier or be distributed over a network.

### BRIEF DESCRIPTION OF THE DRAWINGS

The invention will be readily understood by reference to the following description of embodiments described by way of example only, with reference to the accompanying drawings in which like reference characters represent like elements, wherein:

FIG. 1 shows an assignment table for the assignment of actions to combinations of state and speech category,

FIG. 2 shows a context-free grammar,

FIG. 3 shows a syntactic structure which is assigned to an exemplary utterance,

FIG. 4 shows another syntactic structure which is assigned to the same exemplary utterance, and

FIG. 5 shows a sequence of LR stacks.

### DETAILED DESCRIPTION OF THE EMBODIMENTS

The present invention will now be described with reference to embodiments and examples which are given by way of example only, not limitation. As used herein, any given range is intended to include any and all lesser included ranges.

In natural languages, structural ambiguities occur which have to be resolved for a sequence of applications, for example machine translation and speech synthesis. Such ambiguities and the method according to one aspect of the invention will be explained here by the example “The woman saw the child with the binoculars”. This utterance is ambiguous in that it can mean on the one hand that the woman is looking through the binoculars and in doing so sees the child. On the other hand, the utterance could mean that the woman sees the child, and the child has binoculars.

In the method for computer-supported speech analysis, the utterance is then firstly divided into speech units, each word forming a speech unit. The speech units are then each assigned to speech categories: “The” to the category “Det” for “article”, “woman” to the category “N” for “noun”, “saw” to the category “V” for “verb”, “the” to the category “Det” for “article”, “child” to the category “N” for “noun”, “with” to the category “Prep” for “preposition”, “the” to the category “Det” for “article” and “binoculars” to the category “N” for “noun”.

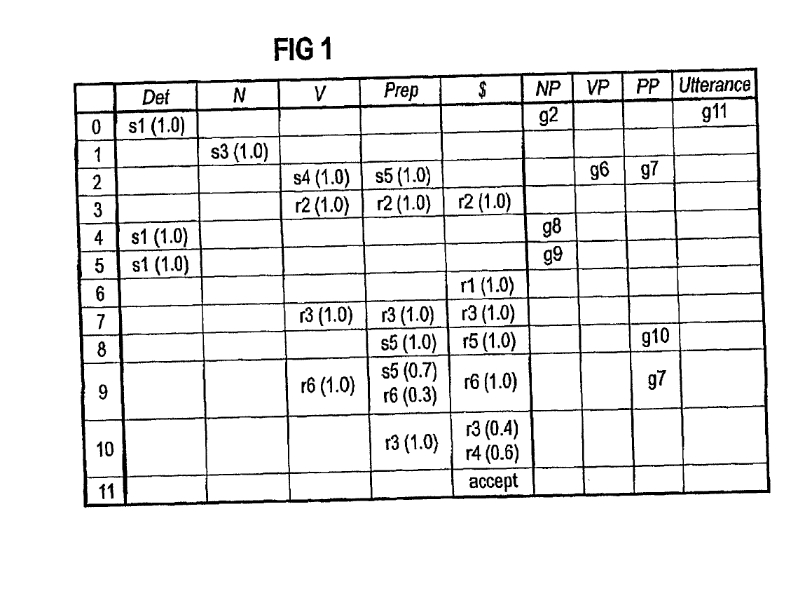

Further steps will be explained with reference to FIG. 1 which represents the specific case of a parsing table, which, however, can also be satisfactorily used to follow the general principle of the method. Firstly, a state “0” is determined. Then, the state “0” is combined with the speech category “Det” of the first speech unit of the utterance. Then, an action “s1” is assigned to the combination of state “0” and speech category “Det”. Because the utterance is still unambiguous at this point, the probability 1 is assigned. The action is “s1” (“shift 1”), which means that the resultant state “1” is determined.

Taking this resultant state as a basis, the method is then carried out again starting from the combination of the state with the speech category of a speech unit. In the example, the order of the speech units in the utterance is allocated to the speech units, and thus also to their categories. For this reason, the resultant state “2” is combined with the speech category “N” of the next speech unit “woman”. The action “s3” is then assigned to this combination of the state “1” with the speech category “woman”, and the resultant state (3) is determined by carrying out the action “s3” (“shift 3”).

This procedure is continued, “reduce” actions occurring in addition to the “shift” actions which only result in a new state being determined. These “reduce” actions firstly cause a grammatical rule to be carried out, the action “rn” bringing about the application of the structural rule (n).

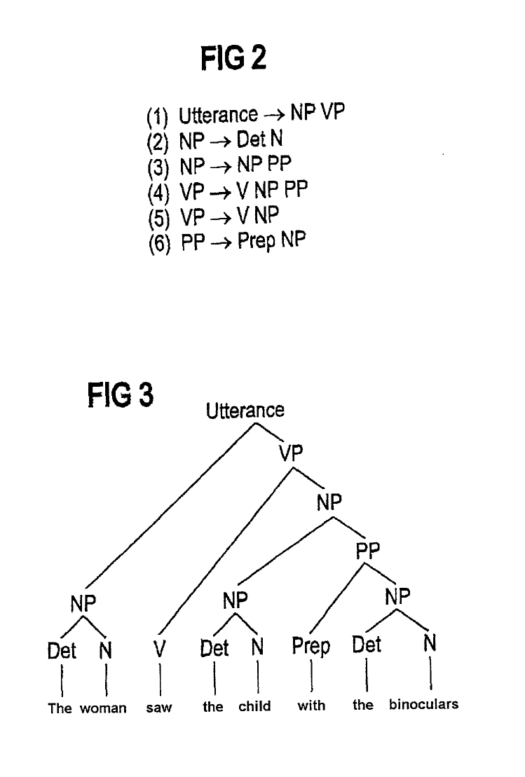

An example of such grammar is illustrated in FIG. 2. This is a context-free grammar with six rules. The symbol “NP” stands here for “noun phrase”, the symbol “PP” for “prepositional phrase” and the symbol “VP” for “verbal phrase”.

If, for example, the action “r2” is assigned to the combination of state (3) and speech category “V”, rule (2) of the grammar is firstly carried out and the speech categories “Det” and “N” are reduced to form the speech category “NP”. Then, the instruction “g2” is carried out under the column “NP” of the parsing table according to FIG. 1, and finally the resultant state “2” is determined at the end of the execution of the action.

In addition, in the parsing table according to FIG. 1 there are the symbols “$” for “end of sentence”, “utterance” and “accept” for the end of the method. See A. V. Aho, R. Sethi and J. D. Ullman “Compilers: Principle, Techniques and Tools”, Addison Wesley, Reading 1986 for the general context of a grammar such as in FIG. 2, with a parsing table as in FIG. 1.

With the combinations of state “9” and speech category “Prep” and of state “10” and speech category “$”, an ambiguous assignment of actions occurs owing to the ambiguity of natural language. This means that more than one action is assigned to a combination of state and speech category. Such a situation cannot be resolved unambiguously with a deterministic method. However, in the given stochastic method it is possible to implement ambiguity by the assignment of the different actions to the combination of state and speech category with a certain probability. Thus, for example for the combination of state “9” and speech category “Prep” the action “s5” has the probability 0.7, and the action “r6” has the probability 0.3. In FIG. 1, the probabilities of the individual actions are each given in brackets after the actions. How these probabilities are determined is explained below.

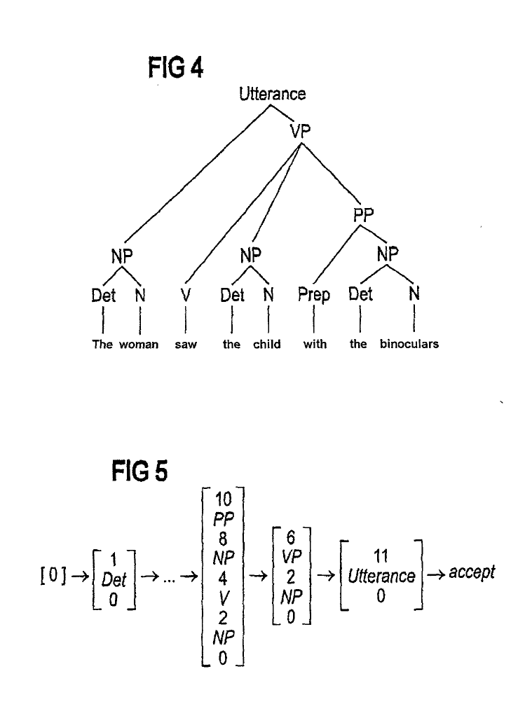

For the exemplary utterance, there are in total the two possible sequences of actions “s1”→“s3”→“r2”→“s4”→“s1”→“s3”→“r2”→“s5”→“s1”→“s3”→“r2”→“r6”→“r3”→“r5”→“r1”→accept and “s1”→“s3”→“r2”→“s4”→“s1”→“s3”→“r2”→“s5”→“s1”→“s3”→“r2”→“r6”→“r4”→“r1”→accept. Accordingly, the two syntactic structures illustrated in FIGS. 3 and 4 as parsing trees are assigned to the utterance.

During the method, the probabilities of the successive actions for the respective alternatives are multiplied by one another, or added in the case of logarithmic probabilities. In this way, an overall probability can be assigned to each of the alternative structures which are found. It is thus possible to select the most probable structure which can be used as the basis, for example, for a machine translation or speech synthesis of the utterance.

For a precise analysis it is then highly important to determine the probabilities of the actions as precisely as possible. According to the prior art, these are determined as a function of the following variables: the states, in the example “0” to “11”, including the resultant states because these form the states when the method is carried out again, the speech categories, here “Det” to “$” or up to “utterance”, and the actions, in the example “s1” to “s5” and “r1” to “r6”. These syntactic variables form the context in the narrower sense because they are included directly in the assignment of the actions to the combinations of state and speech category.

According to one aspect of the invention, the probabilities are determined as a function of the expanded context. These include syntactic variables which the context does not have in the narrower sense. Furthermore, the probabilities can also continue to depend on the context in the narrower sense. This is not absolutely necessary, but will generally be appropriate.

Thus, the exemplary utterance is assigned the “description” dialogue act. If, on the other hand, the “question” dialogue act were assigned to the same exemplary utterance, this would lead to other probabilities for the actions because in a natural language the probability of a question having a specific syntactic structure is different from that of a “description” having a specific syntactic structure.

The same applies to the syntactic variable “speech unit” itself. Thus, in the exemplary utterance, not only the speech category “noun” of the speech unit “woman” could be evaluated in order to determine the probabilities, but also the speech unit “woman” itself, or information associated with this speech unit, for example the fact that the speech unit “woman” occurs before a prepositional phrase with a certain degree of frequency, could be evaluated. In the expanded context, this information can be taken into account not only in determining the probabilities for actions which are assigned to the combination of a state and of the speech category assigned to the speech unit “woman”. Because the expanded context can also contain other speech units and information associated with them for each combination of state and speech category, it is in fact also possible according to the inventor's method to allow the information associated with the speech unit “woman” also to be included at other points of the method.

Furthermore, the syntactic variable “speech style” can also be taken into account in the determination of the probabilities. If, for example, the exemplary utterance is present in the speech style “fairy tale”, this can lead to other probabilities for the actions as if it is present in the speech style “newspaper text”.

In the LR-parsing, a stack is generally used. An excerpt from an example of such a method of operation is given in FIG. 5, only the alternative according to FIG. 4 being represented for the exemplary utterance.

Firstly, a state “0” is determined. Next, the state “0” is combined with the speech category “Det” of the first speech unit of the utterance. An action “s1” is then assigned to the combination of state “0” and speech category “Det”. Because the utterance is still unambiguous at this point, the probability 1 is assigned. The action is “s1” (“shift 1”), which means that the resultant state “1” is determined and the speech category of the first speech unit is placed on the stack. The continuation of the parsing method occurs in a way analogous to the above embodiments in the procedure which is known for parsing methods.

In order to determine the probabilities for the actions, other variables of the expanded context cant be evaluated when working with a stack. This is, in the first instance, the extreme speech category in the stack, that is to say the uppermost or lowermost speech category which is present at the respective step in the stack.

Secondly, a dependence on the extreme non-terminal speech category in the stack has proven appropriate. A context-free grammar is composed of rules, terminal and non-terminal speech categories and a start symbol. For the context-free grammar according to FIG. 2, “utterance” is the start symbol. The non-terminal speech categories are situated on the left hand side of the arrows. There are rules for an expansion for these speech categories. In contrast, there are no expansion rules for the terminal speech categories.

In the exemplary utterance, the probabilities with which the actions are assigned to the combinations of state and speech category are determined as a function of speech categories, states, including resultant states, actions, dialogue act, speech unit, speech style, extreme non-terminal speech categories and extreme speech categories. The probability P(T|W) of a syntactic structure T as a function of the utterance W is obtained from:

P(T|W)=P(T)×P(W|T)

P(T) and P(W|T) can be approximated as follows:

$$P ( W / T ) \approx {\prod }_{{w}_{1} ϵ W} P ( {w}_{i} \vert {l}_{i} )$$

wᵢ being the i-th speech unit of the utterance W and lᵢ being the speech category assigned to wᵢ,

$$P ( T ) \approx {\sum }_{j = 1}^{\vert d \vert} P ( {a}_{d , j} \vert {k}_{d , j} )$$

the structure T having been produced by |d| number of actions a which were ordered with the serial index j (j=1 . . . |d|). k_{d,j} will be the context in which the action a_{d,j} is carried out. The probabilities P(a_{d,j}|k_{d,j}) will be calculated here by the approximation

$$P ( a \vert k ) = {\sum }_{1} {α}_{i} \cdot P ( a \vert {K}_{i} )$$

Kᵢ will refer to the abovementioned subcontexts. aᵢ will be suitably selected, the sum of all aᵢ yielding 1.

The probabilities are not necessarily produced a priori but only in the respective assignment situation. In particular when the tables are large, a calculation of all the probabilities which may occur would result in an inappropriate and largely also unnecessary expenditure in terms of computation and time.

The method of computer-supported speech analysis is carried out on a data processing system.

An arrangement for computer-supported speech analysis can be implemented in the form of an appropriately configured data processing system. This has:

reception unit for receiving the utterance,

division unit for dividing the utterance into the speech units,

assignment unit for assigning the speech units to the speech categories,

determining unit for determining a state,

combination unit for combining the state with the speech category of a speech unit,

assignment unit for assigning one or more actions to the combination of state and speech category with a probability which depends on the expanded context, and

determining unit for determining a number of resultant states resulting from the execution of actions.

While the invention has been described in detail with respect to specific embodiments thereof, it will be appreciated that those skilled in the art, upon attaining an understanding of the forgoing may readily conceive of alterations to, variations of and equivalents to these embodiments. Accordingly, the scope of the present invention should be assessed as that of the appended claims and any equivalents thereto.

What is claimed is:

1. A method for computer-supported speech analysis, in which a syntactic structure is assigned to an utterance, having
a context in the narrower sense for combinations of states and speech units, which is composed of speech categories, states, including resultant states, and actions,
an expanded context for the combinations of states and speech units which contains syntactic variables which are not contained in the context in the narrower sense,
and having the following steps
the utterance divided into the speech units,
the speech units are assigned to the speech categories,
a state is determined,
the state is combined with the speech category of a speech unit,
one or more actions are assigned to the combination of state and speech category with a probability which depends on the expanded context,
a number of resultant states is determined by carrying out the actions, and
the method is carried out again starting from the combination of the state with the speech category of a speech unit for at least one of the resultant states so that further speech units of the utterance are processed.

2. The method as claimed in claim 1, wherein the expanded context contains the dialogue act of the utterance.

3. The method as claimed in claim 1, wherein the expanded context contains the speech unit itself and/or further speech units of the utterance.

4. The method as claimed in claim 1, wherein the expanded context contains the speech style in which the speech unit and/or the utterance was spoken.

5. The method as claimed in claim 1, wherein an order is allocated to the speech units, and in that the speech units are processed in this allocated order.

6. The method as claimed in claim 5, wherein the allocated order corresponds to the order, or the inverted order of the speech units in the utterance.

7. The method as claimed in claim 1, wherein the expanded context is divided with respect to the syntactic variables into a plurality of subcontexts.

8. The method as claimed in claim 1, wherein the method is a stochastic parsing, in particular a stochastic LR parsing.

9. The method as claimed in claim 8, wherein one or more actions are assigned to a combination of state and speech category by a parsing table.

10. The method as claimed in claim 8, wherein the method has a stack.

11. The method as claimed in claim 10, wherein the expanded context contains an extreme speech category of the stack.

12. The method as claimed in claim 10, wherein the expanded context contains an extreme non-terminal speech category of the stack.

13. An system for computer-supported speech analysis, in which a syntactic structure is assigned to an utterance, having
a context in the narrower sense for combinations of states and speech units, which is composed of speech categories, states, including resultant states, and actions,
an expanded context for the combinations of states and speech units which contains syntactic variables which are not contained in the context in the narrower sense,
the system comprising:
a dividing unit to divide the utterance into the speech units,
a first assigning unit to assign the speech units to the speech categories,
a first determining unit to determine a state,
a combining unit to combine the state with the speech category of a speech unit,
a second assigning unit to assign one or more actions to the combination of state and speech category with a probability which depends on the expanded context,
a second determining unit to determine a number of resultant states is by carrying out the actions, and
a repeating unit to reactivate the combining unit, the second assigning unit and the second determining unit, for at least one of the resultant states so that further speech units of the utterance are processed.

14. (NEW) At least one computer readable medium storing at least one program for controlling at least one computer to perform a method in which a syntactic structure is assigned to an utterance, having
a context in the narrower sense for combinations of states and speech units, which is composed of speech categories, states, including resultant states, and actions,
an expanded context for the combinations of states and speech units which contains syntactic variables which are not contained in the context in the narrower sense,
the method comprising:
dividing the utterance into the speech units, assigning the speech units to the speech categories,
determining a state,
combining the state with the speech category of a speech unit,
assigning one or more actions to the combination of state and speech category with a probability which depends on the expanded context,
determining a number of resultant states is by carrying out the actions, and
repeating the method starting from the combination of the state with the speech category of a speech unit for at least one of the resultant states so that further speech units of the utterance are processed.
